(19) United States
(12) Patent Application Publication
(10) Pub. No.: US 2026/0007097 A1
(43) Pub. Date: Jan. 8, 2026

(54) Optical Sensing of Crop Processing Components of Harvester

(71) Applicant: DEERE & COMPANY, Moline, IL (US)

(72) Inventors: TANUJ KUMAR, PUNE (IN); NIKHIL ANANDWADE, KOLHAPUR (IN); NATHAN R. VANDIKE, GENESEO, IL (US)

(21) Appl. No.: 18/763,168

(22) Filed: Jul. 3, 2024

(51) Int. Cl. A01D 41/127; G06T 7/00

(52) U.S. Cl. CPC A01D 41/1274; G06T 7/0004

(57) ABSTRACT

An agricultural harvester has a crop processing component status monitor and control system including an optical sensor and a controller. The optical sensor is used to capture an image of the crop processing component or an element coupled to or included by the actuator and to generate a signal indicative of the image of the crop processing component or the element. The controller includes a processor and a memory having a status monitor and control algorithm stored therein. The processor is operable to execute the status monitor and control algorithm to receive the signal indicative of the image of the crop processing component or the element from the optical sensor, analyze the image of the crop processing component or the element to obtain a value, and determine, based on the value, the status of the crop processing component.

### TECHNICAL FIELD

The present disclosure relates generally to an agricultural harvester, in particular to optical sensing of crop processing component(s).

### BACKGROUND

Agricultural harvesters harvest crop from a field and process the harvested crop to separate grain from crop residue. In general, the harvesters have crop processing components to process the crop, such as threshing, separating, cleaning, and chopping, etc. The crop processing components may be moved by actuators to engage and process the crop.

### SUMMARY

Accordingly to a disclosure, an agricultural harvester includes a frame, a ground engaging device, a header, a crop processing system, and a crop processing component status monitor and control system. The frame has a first end and a second end spaced from the first end along a central longitudinal axis of the frame. The ground engaging device is coupled to the frame and is configured to move the frame in a direction of travel during an operation. The header is configured to collect crop and convey the crop to a feederhouse coupled between the header and the frame. The crop processing system includes a crop processing component and an actuator. The crop processing component is configured to engage the crop. The actuator is coupled with the crop processing component and is configured to move the crop processing component to engage the crop. The crop processing component status monitor and control system includes an optical sensor and a controller. The optical sensor is configured to capture an image of the crop processing component or an element coupled to or included by the actuator and to generate a signal indicative of the image of the crop processing component or the element. The controller includes a processor and a memory having a status monitor and control algorithm stored therein. The processor is operable to execute the status monitor and control algorithm to receive the signal indicative of the image of the crop processing component or the element from the optical sensor, analyze the image of the crop processing component or the element to obtain a value, and determine, based on the value, the status of the crop processing component.

In one aspect of the disclosure, determining the status of the crop processing component includes determining whether an abnormal status is present on the crop processing component.

In one aspect of the disclosure, the processor is operable to execute the status monitor and control algorithm to transmit an alert signal to an output device when the processor determines the abnormal status is present on the crop processing component.

In one aspect of the disclosure, determining the status of the crop processing component includes identifying a position of the crop processing component based on the value.

In one aspect of the disclosure, the processor is operable to execute the status monitor and control algorithm to compare the position of the crop processing component, derived from the value, with a desired position set by an output device, and command the actuator to move the crop processing component from the position to the desired position when the position of the crop processing component is not the desired position.

In one aspect of the disclosure, the agricultural harvester includes a position sensor configured to sense a position of the element coupled to or included by the actuator and generate a signal indicative of a sensed position of the element correlated to an estimated position of the crop processing component. The processor is operable to execute the status monitor and control algorithm to determine the estimated position of the crop processing component based on the signal indicative of the sensed position of the element and to calibrate the estimated position of the crop processing component, based on the value, to reflect the position of the crop processing component.

In one aspect of the disclosure, the processor executes the status monitor and control algorithm to receive a signal indicative of a first sensed position of the element represented by a first electric value from the position sensor, receive a signal indicative of the image of the crop processing component or the element at a first position of the crop processing component from the optical sensor, analyze the image of the crop processing component or the element at the first position of the crop processing component to obtain a first value corresponding to the first position, and record a first sample including the first value corresponding to the first position and the first electric value.

In one aspect of the disclosure, the processor executes the status monitor and control algorithm to trigger the actuator to move the crop processing component to a second position, receive a signal indicative of a second sensed position of the element represented by a second electric value from the position sensor, receive a signal indicative of the image of the crop processing component or the element at the second position of the crop processing component from the optical sensor, analyze the image of the crop processing component or the element at the second position to obtain a second value corresponding to the second position, record a second sample including the second value corresponding to the second position and the second electric value, and generate a correlation between the value corresponding to the position of the crop processing component and an electric value from the position sensor based on the first sample and the second sample.

In one aspect of the disclosure, the crop processing component includes louvers of a sieve or louvers of a chaffer, and the position of the crop processing component reflects the opening defined by the louvers of the sieve or louvers of the chaffer.

In one aspect of the disclosure, the crop processing component includes a deck plate of the header, louvers of a sieve, louvers of a chaffer, separator vanes, a concave, a shaking pan, a chopping rotor of a chopper, or a knife bank of the chopper.

In one aspect of the disclosure, the agricultural harvester includes a machine status monitoring system configured to monitor the status of the agricultural harvester and generate a signal indicative of the status of the agricultural harvester. The memory includes an initiation algorithm stored therein. The processor is configured to execute the initiation algorithm to receive the signal indicative of the status of the agricultural harvester and determine whether to execute the status monitor and control algorithm based on the signal indicative of the status of the agricultural harvester.

In one aspect of the disclosure, the machine status monitoring system includes a machine status monitor or a timer configured to record a time after a last execution of the status monitor and control algorithm.

In one aspect of the disclosure, the processor determines whether to execute the status monitor and control algorithm based on whether the time is greater than a threshold.

In one aspect of the disclosure, the status of the agricultural harvester includes at least one of a presence of a mass flow of the crop, a position of the agricultural harvester relative to a field boundary position, an operational state of the agricultural harvester, or the position of the agricultural harvester located inside or outside coverage map.

In one aspect of the disclosure, the operational state includes non-harvesting state, transport state, or unloading state.

In one aspect of the disclosure, the machine status monitor includes at least one of a mass flow sensor configured to sense the mass flow of the crop, a speed sensor, a vehicle position sensor, or a receiver configured to receive a signal from another agricultural harvester or an operation station.

Accordingly to a disclosure, a method of monitoring and controlling a crop processing component of an agricultural harvester includes capturing an image of the crop processing component and generating a signal indicative of the image of the crop processing component by an optical sensor, receiving the signal indicative of the image of the crop processing component from the optical sensor by a controller, analyzing the image of the crop processing component, by the controller, to obtain a value, and determining, based on the value, the status of the crop processing component.

In one aspect of the disclosure, determining the status of the crop processing component includes determining whether an abnormal status is present on the crop processing component.

In one aspect of the disclosure, determining the status of the crop processing component includes identifying a position of the crop processing component based on the value, wherein the crop processing component is moved by an actuator to engage the crop.

In one aspect of the disclosure, the method also includes comparing the position of the crop processing component, derived from the value, with a desired position set by an output device, and commanding an actuator to move the crop processing component from the position to the desired position when the position of the crop processing component is not the desired position.

Accordingly to a disclosure, an agricultural harvester includes a frame, a ground engaging device, a header, a component, and a crop processing component status monitor and control system. The frame has a first end and a second end spaced from the first end along a central longitudinal axis of the frame. The ground engaging device is coupled to the frame and is configured to move the frame in a direction of travel during an operation. The header is configured to collect crop and convey the crop to a feederhouse coupled between the header and the frame. The component is configured to engage the crop. The component status monitor and control system includes an optical sensor and a controller. The optical sensor is configured to capture an image of the component and to generate a signal indicative of the image of the component. The controller includes a processor and a memory having a status monitor and control algorithm stored therein. The processor is operable to execute the status monitor and control algorithm to receive the signal indicative of the image of the component from the optical sensor, analyze the image of the component to obtain a value, and determine, based on the value, the status of the component.

In one aspect of the disclosure, determining the status of the component includes determining whether an abnormal status is present on the component.

In one aspect of the disclosure, the processor is operable to execute the status monitor and control algorithm to transmit an alert signal to an output device when the processor determines the abnormal status is present on the component.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a side elevational view showing an agricultural harvester.

FIG. 2A is a cross-sectional view taken along section line 2.

FIG. 2B is a cross-sectional view taken along section line 2 with a concave actuator extending to increase the clearance.

FIG. 3A is an enlarged simplified side perspective view of vanes in a normal position.

FIG. 3B is an enlarged simplified side perspective view of the vanes in an advanced position.

FIG. 4A is a simplified top perspective view of a chaffer or a sieve with an opening defined by louvers.

FIG. 4B is another simplified top perspective view of the chaffer or the sieve with an opening defined by the louvers smaller than the opening shown in FIG. 4A.

FIG. 5A is an enlarged simplified side view of a chopper, where a knife bank is in a first position.

FIG. 5B is another enlarged simplified side view of the chopper, where the knife bank is in a second position.

FIG. 6A is a simplified block diagram of a crop processing component status monitor and control system, which performs auto calibration.

FIG. 6B is a simplified block diagram of the crop processing component status monitor and control system, which monitors an abnormal status and alerts an operator.

FIG. 6C is a block diagram of the crop processing component status monitor and control system, which illustrates various crop processing components and corresponding optical sensors.

FIG. 7 is a flowchart showing a method of calibration and abnormal status detection.

FIG. 8 is a flowchart showing a method of abnormal status detection.

Like reference numerals are used to indicate like elements throughout the several figures.

### DETAILED DESCRIPTION

The present disclosure includes a crop processing component status monitor and control system of an agricultural harvester that can monitor the status of the crop processing component and control the crop processing component or other component in response to the status of the crop processing component. The crop processing component status monitor and control system may include an optical sensor and a controller. The optical sensor captures the images of the crop processing component or elements configured to move the crop processing component (i.e., the actuator or linkage coupled between the actuator and the crop processing component) for the controller to analyze the images and determine the status of the crop processing component. In one implementation, the status of the crop processing component may include the position of the crop processing component. The crop processing component status monitor and control system may perform automatic adjustment and/or automatic calibration of the crop processing component. In another implementation, the status of the crop processing component may include normal status and abnormal status. The abnormal status may include wear (e.g., missing material of the crop processing component, and unexpected shape, etc.), damage, plugging (the crop cannot pass through or move relative to the crop processing component), and material buildup (the buildup impedes crop flow or effective engagement/interaction between the crop flow and the crop processing component), etc. If the crop processing component status monitor and control system determines the abnormal status is present on the crop processing component, a controller of the system transmits an alert signal to an output device to alert the operator. Here, the crop processing component may include, but is not limited to, at least one of deck plates, louvers of a sieve, louvers of a chaffer, vanes above an axial rotor, a concave(s), louvers of a sieve, louvers of a chaffer, a shaking pan (return pan), a knife bank of a chopper, or a chopping rotor of the chopper.

When the status of the crop processing component includes the position of the crop processing component, the controller of the crop processing component status monitor and control system may identify a position of the crop processing component via the images captured by the optical sensor. The controller may command an actuator coupled with the crop processing component to move the crop processing component to a desired position determined by an input device operated by the operator when the current position of the crop processing component is not the desired position. If the status (position) of the crop processing component still cannot be moved to the desired position, the controller may also transmit an alert signal to an output device to alert the operator. In addition, the crop processing component status monitor and control system may calibrate the measurement of a position sensor. The position sensor, in general, may be coupled to the actuator. The position sensor may be directly coupled to the actuator (e.g., installation) or indirectly coupled to the actuator through a linkage or a connection between the actuator and the crop processing component. In other words, the position sensor may be coupled to an element, which may include or is coupled to the actuator. By sensing the position of the element through the position sensor, the controller can determine the position of the crop processing component, even when the crop processing component is processing the crop. The controller may use the images from the optical sensor to determine the position of the crop processing component and establish the correlation between the position of the of the crop processing component and the electric characteristics (voltage, current, etc.) of the signal from the position sensor for automatic calibration. The crop processing component may include, but is not limited to, at least one of deck plates, vanes above an axial rotor, a concave(s), louvers of a sieve, louvers of a chaffer, a knife bank of a chopper, or a chopping rotor of the chopper.

Currently, some calibrations on an agricultural harvester need an operator intervention. For instance, during chaffer/sieve position calibration, the operator may have to close the louvers and then open the louvers to a specific position/calibration position (e.g., 5 mm opening). The agricultural harvester may include a position sensor, which is coupled to the actuator that drives the louvers, transmitting a signal indicative of the position of the actuator in the form of a voltage or current value, to the controller to calculate the opening of the louvers. The purpose of the calibration is to ensure the opening of the louvers is determined by the controller and the value of which illustrated by a display represents the actual value of the opening. The opening here is defined by a distance/gap between two adjacent rows of louvers, which is changeable in response to the angles of the louvers. A display, which is connected to a controller, instructs the operator to fully close the chaffer. The operator may need to leave the cab, go down on the side of the agricultural harvester, open an inspection window or a panel of the agricultural harvester to observe, and use a side switch or manual adjustment to fully close the louvers (i.e., 0 mm opening). Then the operator goes up to the cab, and the display instructs the operator to open the chaffer to the specific position. The operator then goes back the inspection window or an operating opening, uses the switch on the rear of the agricultural harvester to open the louvers to the specific position (e.g., 5 mm opening) and a ruler, which is 5 mm thickness, for example, to verify that the louvers are actually at the specific position. Then the operator again goes to the cab and confirms that the louvers are at the specific position through an input device (e.g., the display, which is a touch screen). A memory coupled to the controller stores the value of the voltage (or current) corresponding to the specific position of the louvers (e.g., 5 mm opening). In response to the confirmation, the controller may control actuators to fully open and to fully close to identify the moveable ranges of the louvers. The memory coupled to the controller may store the values of the voltage (or current) corresponding to the fully open position and the fully closed position of the louver. With the above setting and the signals from the position sensor, the controller may interpolate and calculate the opening of the louvers (e.g., the actual opening of the louvers) in the moveable ranges of the louvers. The crop processing component status monitor and control system in the present disclosure simplifies the calibration process and minimizes the operator's intervention.

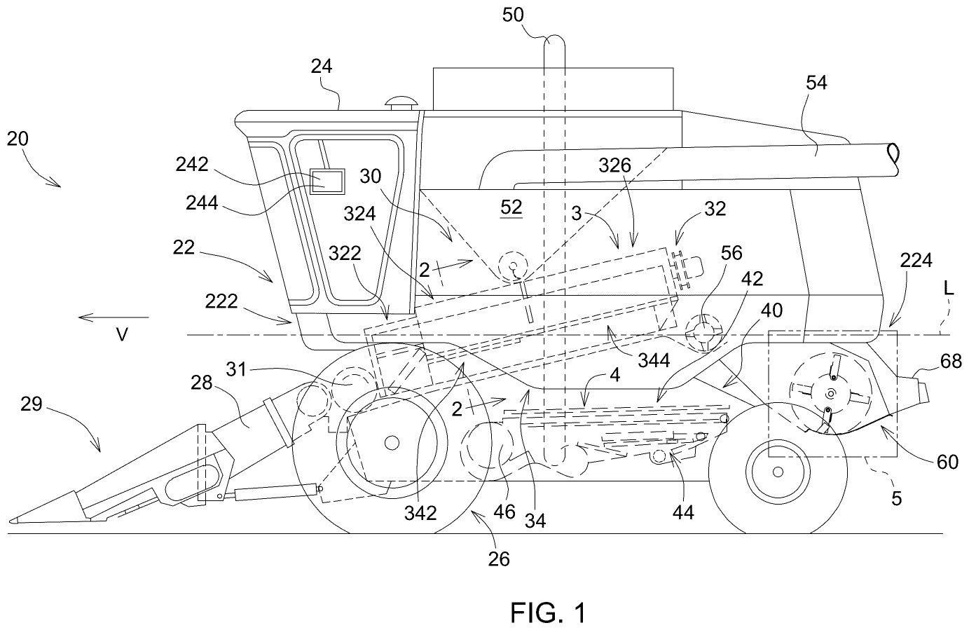

Referring to FIG. 1, an agricultural harvester 20 is configured to move in a forward direction of travel over a field to harvest crop from the field. The agricultural harvester 20 processes the crop, separating grain from crop residue (e.g., straw, stalks, cobs, leaves, chaff), storing the separated grain, and returning crop residue back to the field.

In general, the agricultural harvester 20 may include a frame 22, an operator's station 24, a ground engaging device 26, a feederhouse 28, and a header 29. The frame 22 has a first end 222 and a second end 224 spaced from the first end 222 along a central longitudinal axis L of the frame 22. The operator's station 24 (cab) is equipped on the frame 22 and allows a user/operator to control the agricultural harvester 20. The operator's station 24 may include an input device 242 and an output device 244. The operator may use the input device 242, such as steering wheel, touch screen, joystick to control the agricultural harvester 20. Some input devices 242 may be used to move or adjust one or more crop processing components CPC, which are described later. The operator may use the output device 244, such as a display (or touch screen) or a speaker, to observe or understand the status of the agricultural harvester 20 and the crop processing component(s) CPC. In another embodiment where the agricultural harvester 20 is an autonomous agricultural harvester or is controlled by a workstation remotely, the operation's station 24 may be omitted. The ground engaging device 26 is coupled to the frame 22 and configured to support the frame 22 relative to the ground and to move the frame 22 in a direction V of travel during operation. The agricultural harvester 20 may be driven in the direction V of travel hydraulically, mechanically, and/or electrically. The ground engaging device 26 may be wheels, tracks, or a combination thereof.

The header 29 is disposed at a forward end of the agricultural harvester 20. The header 29 is configured to cut, gather, and transport crop rearwardly to the feederhouse 28. The header 29 includes but is not limited to a draper, a corn head, a belt pickup. The belt pickup uses rubber belts to pick up cut crop. The feederhouse 28 is pivotably coupled to the frame 22 and configured for attachment to the header 29. The feederhouse 28 advances crop, through a slope conveyor (not shown), received from the header 29 into the body of the agricultural harvester 20 for further processing, such as threshing and separating. In some implementations, when the header 29 is a corn head, for example, the header 29 includes multiple row units 292. The row units 292 harvest corn from individual rows of crop and convey the harvested corn to an auger (not shown) for conveyance into the feederhouse 28. Each row unit 292 may include deck plates 294 (stripper plates) having a left deck plate and right deck plate. The left deck plate and the right deck plate have inner edges spaced apart to define a throat, which receives stalks of an aligned row as the row unit moves along the row of crops. The header 29 also includes a deck plate actuator 296 configured to move one of the deck plates relative to the other deck plate of the same row unit 292 to change the width or size of the throat. A position sensor 298 sensing the position of the deck plate actuator 296 or a linkage coupled between the deck plate actuator 296 and the deck plates 294 (collectively referred to as a deck plate element) and generating a signal indicative of a sensed position of the deck plate element correlated to the position of the deck plates 294.

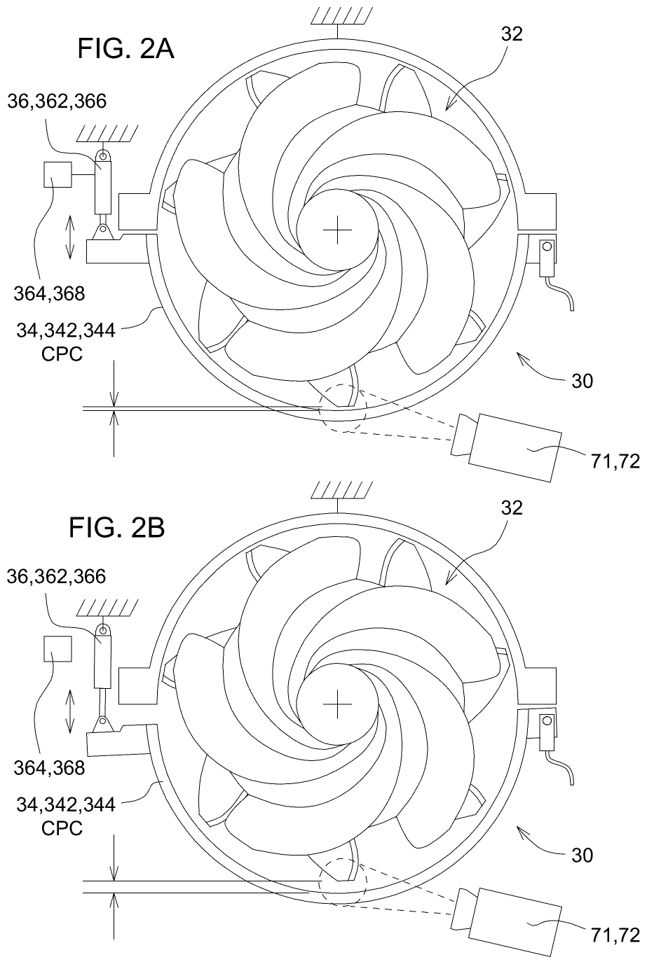

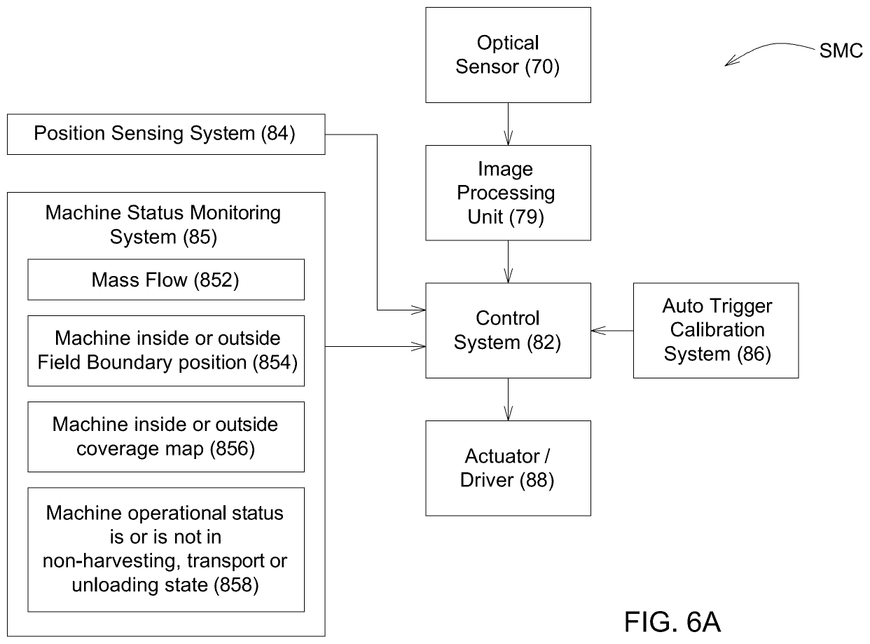

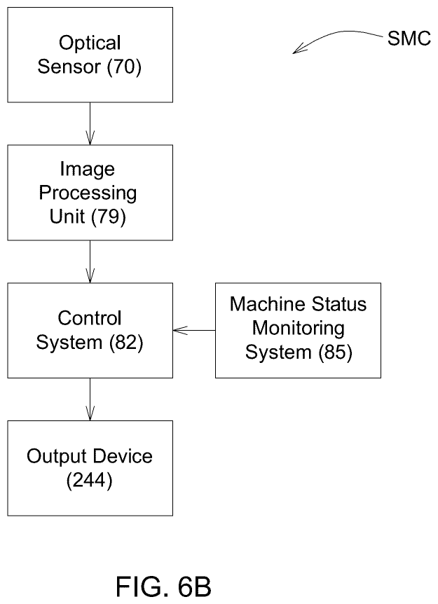

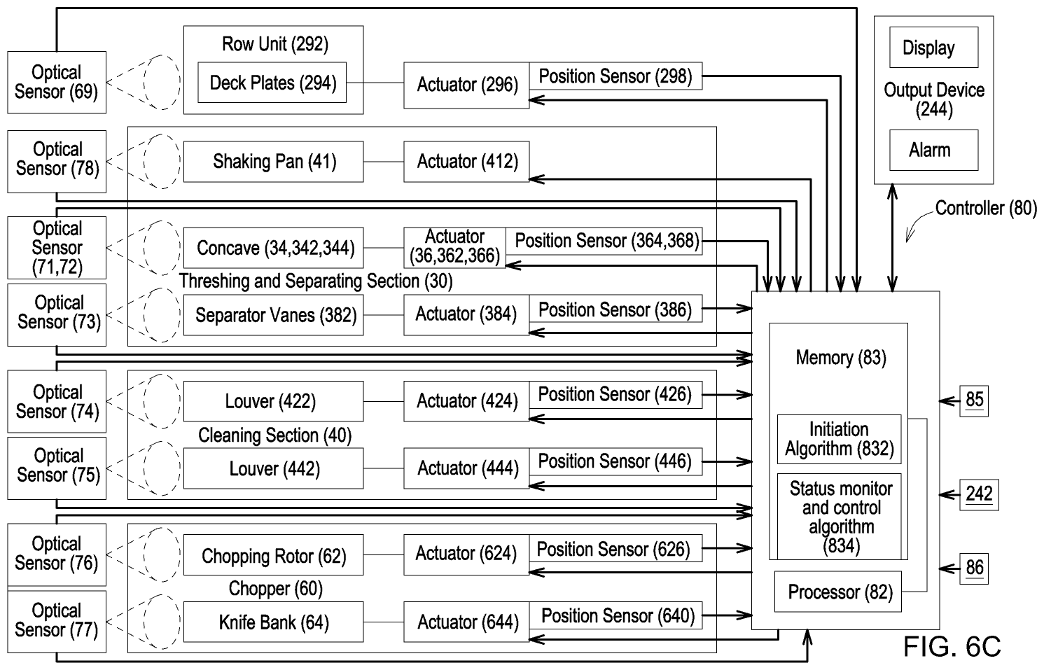

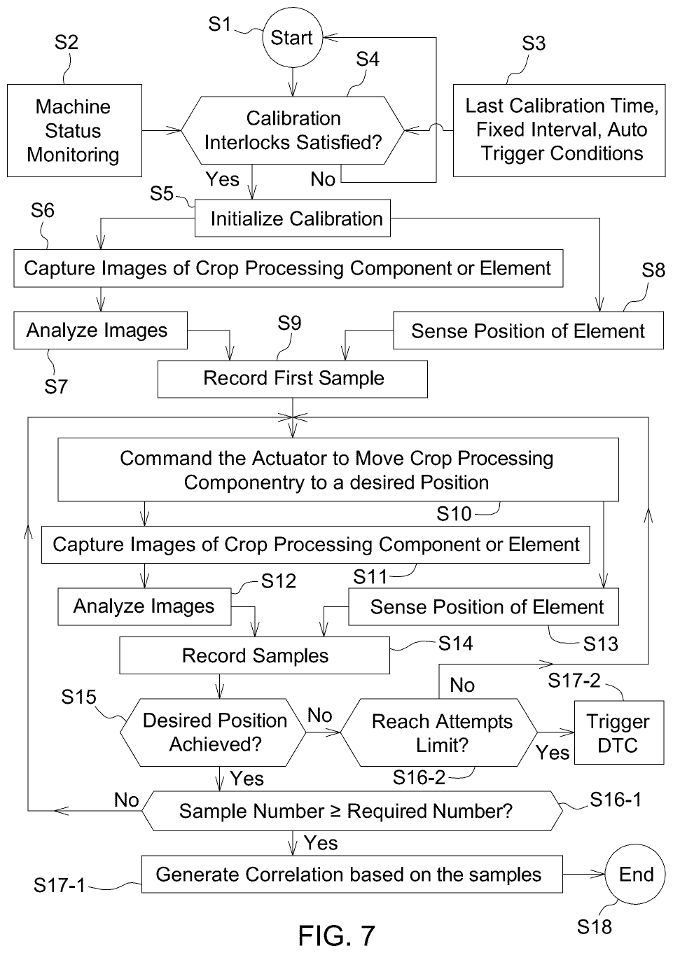

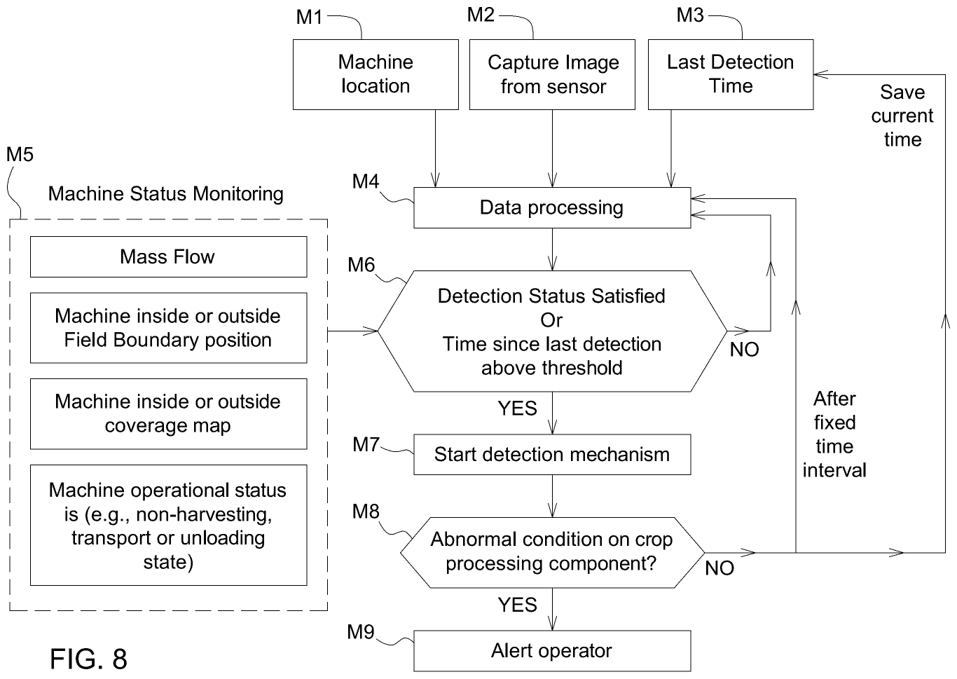

Referring to FIG. 1, the agricultural harvester 20 may also include a threshing and separating section 30 downstream the feederhouse 28, a cleaning section 40, a clean grain elevator 50, a grain tank 52, an unloader 54, a beater 56, a chopper 60 and a spreader 68. The threshing and separating section 30 threshes crop and further separates grain from crop residue. The threshing and separating section 30 may include a feed accelerator 31 guiding the crop to an axial rotor 32. Here, the axial rotor 32 is illustrated for demonstrative purpose. In another implementation, the threshing and separating section 30 may include two or more axial rotors 32 or lateral rotor(s) (not shown) for threshing and/or separating purpose. The axial rotor 32 includes a charging portion 322, threshing portion 324, and separating portion 326. The charging portion 322 is arranged at the front end of the axial rotor 32. The threshing portion 324 and the separating portion 326 are positioned downstream in the longitudinal direction and to the rear of the charging portion 322. At least one or more concave 34 is/are positioned under the axial rotor 32 and spaced apart from the axial rotor 32. In this example, a first concave 342 (thresher basket) is disposed below the threshing portion 324 and a second concave 344 (the separating grate) is disposed below separating portion 326. The threshing and separating section 30 may include one or more actuators 36 to move the concave(s) 34. In the example, as shown in FIGS. 2A, 2B, 6C, a concave actuator 362 is configured to move the first concave 342, with a position sensor 364 sensing the position of the concave actuator 362 or a linkage coupled between the concave actuator 362 and the first concave 342 (collectively referred to as a first concave element) and generating a signal indicative of a sensed position of the first concave element correlated to the position of the first concave 342. The position sensor 364 may be connected to the concave actuator 362. Similarly, a concave actuator 366 is configured to move the second concave 344, with a position sensor 368 sensing the position of the concave actuator 366 or a linkage coupled between the concave actuator 366 and the second concave 344 (collectively referred to as a second concave element) and generating a signal indicative of a sensed position of the second concave element correlated to the position of the second concave 344. The position sensor 368 may be connected to the concave actuator 366. Because the first concave 342, the second concave 344, the concave actuator 362, and the concave actuator 366 are configured as similar structure in regard to the movement, the concave 34 shown in FIGS. 2A and 2B can be the first concave 342 or the second concave 344; the actuator 36 shown in FIGS. 2A, 2B can be the concave actuator 362 or the concave actuator 366; the sensor shown in FIGS. 2A, 2B can be the position sensor 364 or position sensor 368. Adjusting the clearance between the concave(s) 34 and the axial rotor 32 may permit a good threshing or separating result, depending on the crop condition. For example, a greater concave clearance may fit dry and easy threshing conditions; on the contrary, a narrower concave clearance may fit normal or tougher conditions. In a conventional or hybrid harvester (not shown), the threshing is done by a rotor drum with concaves, while the separating is accomplished by walkers or rotors with grates. Similar features of the moveable concaves may be also applied to the conventional or hybrid harvester.

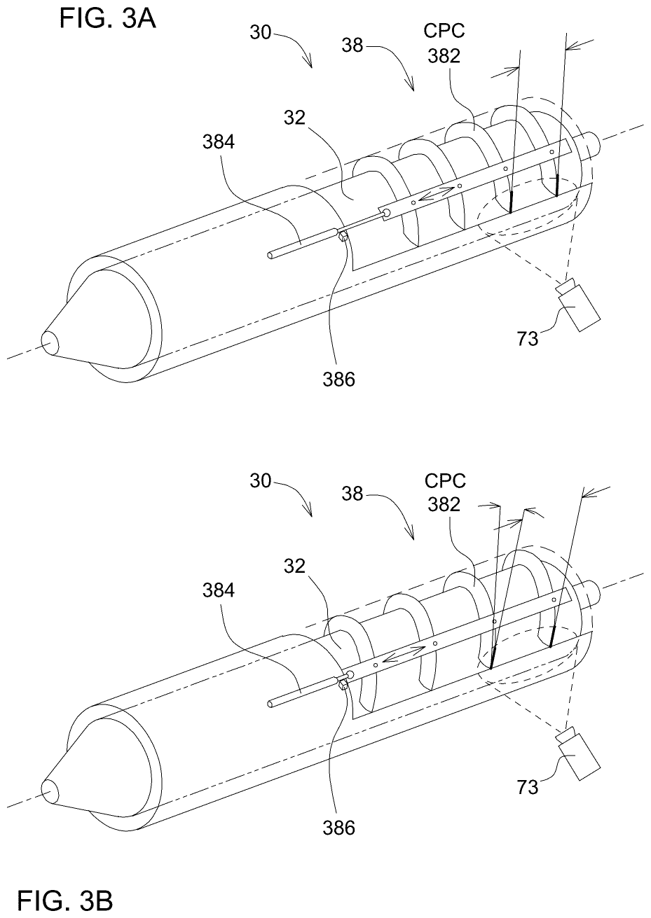

Referring to FIGS. 1, 3A, 3B, the threshing and separating section 30 may include a vane system 38 having multiple vanes 382 arranged above the upper portion of the axial rotor 32 and used to engage and guide the crop flow driven by the axial rotor 32. Different from a rotor cover, which has multiple vanes (not shown) mounted on or protruded from an inner curved surface of the rotor cover that is facing the axial rotor 32, the vanes 382 of the vane system 38 are adjustable so as to change the space between every two adjacent vanes. In this implementation, the vane system 38 is a separator vane system arranged corresponding to the separating portion 326; however, in another implementation, the vane system 38 may be arranged corresponding to the threshing portion 324 (not shown) or both threshing portion 324 and separating portion 326. The vanes 382 may be connected to one or more links, which is/are coupled to a vane actuator 384. The vane actuator 384 is configured to move the link(s) to further move the vanes 382. The movable vanes 382 can be positioned to increase or decrease the rate at which the crop material is guided through the separating portion 326. A position sensor 386 is coupled to the vane actuator 384. The position sensor 386 senses the position of the vane actuator 384 or the link(s)/linkage coupled between the vane actuator 384 and the vanes 382 (collectively referred to as a vane system element) and generates a signal indicative of a sensed position of the vane system element correlated to the position of the vanes 382. Different positions of the vanes 382 may reach different successful grain separation results. For instance, the vanes 382 may be moved from a standard position (FIG. 3A) to an advanced position (FIG. 3B). In the advanced position, the crop spends less time in the separating portion/section, potentially decreasing the separation efficiency. However, the advanced position could result in a longer processed straw length, which may be desirable. Deciding the positions of the vanes 328 depends on the crop types, crop condition, the mass flow, and other factors.

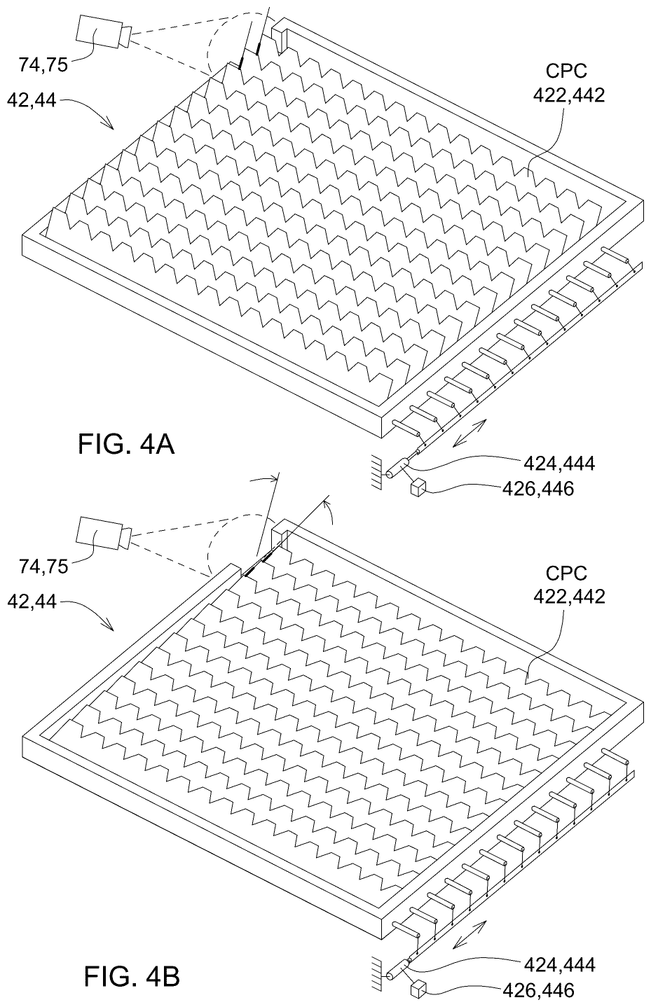

Referring to FIG. 1, the cleaning section 40 may include at least one chaffer 42 and sieve 44 to separate grain from chaff (husks of corn or other plant material) or other small pieces of crop material. The chaffer 42 and the sieve 44 can be oscillated in a fore-and-aft direction. Referring to FIGS. 4A, 4B, the chaffer 42 may include multiple of louvers 422 arranged laterally across the width of the chaffer 42. A chaffer actuator 424 is coupled to the louvers 422 of the chaffer 42 and is used to move the louvers 422 (i.e., tilt the rows of louvers 422) to determine the chaffer opening, which is defined by the gap between every two adjacent rows of louvers 422. It is noted that the “row” described herein is a lateral group of louvers that are all on the same pivot axis. A position sensor 426 can sense a position of the chaffer actuator 424 or a linkage coupled between the chaffer actuator 424 and the louvers 422 (collectively referred to as chaffer element) and generate a signal indicative of a sensed position of the chaffer element correlated to the position of the louvers 422 and/or the chaffer opening. Similarly, the sieve 44 may include multiple louvers 442 arranged laterally across the width of the sieve 44. A sieve actuator 444 is coupled to the louvers 442 of the sieve 44 and is used to move the louvers 442 (i.e., tilt the rows of louvers 442) to determine the extent of the sieve opening, which is defined by the gap between every two adjacent rows of louvers 442. A position sensor 446 can sense a position of the sieve actuator 444 or a linkage coupled between the sieve actuator 444 and the louvers 442 (collectively referred to as sieve element) and generate a signal indicative of a sensed position of the sieve element correlated to the position of the louvers 442 and/or the sieve opening. The chaffer opening of the chaffer 42 is generally designed greater than the sieve opening of the sieve 44 and cleans the crop prior to the sieve 44. Because FIGS. 4A, 4B are used to simply illustrate the movement of the louvers 422 of the chaffer 42 or the louvers 442 of the sieve 44, the louvers shown in FIGS. 4A, 4B can be the louvers 422 or the louvers 442, the actuator shown in FIGS. 4A, 4B can be the chaffer actuator 424 or the sieve actuator 444, the position sensor shown in FIGS. 4A, 4B can be the position sensor 426 or the position sensor 446. The cleaning section 40 may also include a blower 46, as shown in FIG. 1, creating one or more air paths that carries much of the chaff and small/lighter particles to the rear of the agricultural harvester 20 and separates the chaff and small/lighter particles from the grain.

Referring to FIG. 6C, the cleaning section 40 may also include at least one shaking pan 41 (return pan) configured for the crop material transfer. An actuator 412 is coupled to the shaking pan 41. In general, the shaking pan 41 is positioned below the axial rotor 32 and above the chaffer 42 and transfers the crop material to the chaffer 42 and/or sieve 44 to process. Sometimes, abnormal status, such as material buildup, may happen on the shaking pan 41.

Referring to FIG. 1, the clean grain elevator 50 elevates clean grain to the grain tank 52. The unloader 54, which is rotatable, can unload clean grain from the grain tank 52 to a grain cart, a grain truck, or another location. The beater 56 beats crop residue that is received from the threshing and separating section 30 and does not pass to the cleaning section 40 (e.g., straw, stalks, cobs, leaves). The chopper 60 chops the crop residue from the threshing and separating section 30, through the beater 56, to the chopper 60. The spreader 68 is positioned rearward of the chopper 60 and is able to return the chopped residue from the chopper 60 to the field.

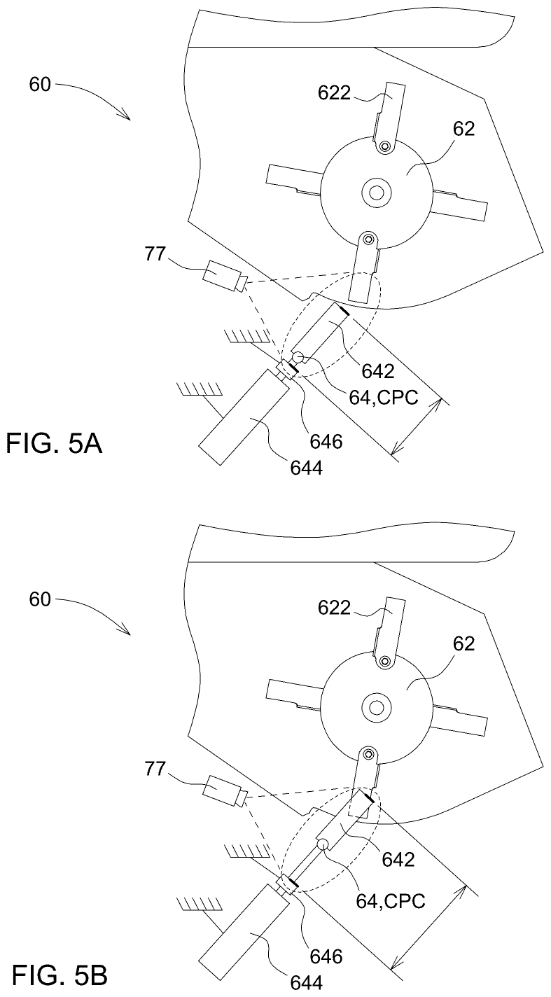

Referring to FIGS. 1, 5A, 5B, the chopper 60 may include a chopping rotor 62 and a knife bank 64. The chopping rotor 62 is carried by the frame or an external housing and includes a plurality of pendulously mounted knife blades 622 configured to chop the crop when the chopping rotor 62 is rotating. The knife bank 64 includes a plurality of stationary knife blades 642 and is adjustably movable toward and away from the chopping rotor 62. The chopper 60 may also include a knife bank actuator 644 used to move the knife bank 64 toward and away from the chopping rotor 62. A position sensor 646 is coupled to the knife bank actuator 644. The position sensor 646 senses the position of the knife bank actuator 644 or a linkage coupled between the knife bank actuator 644 and the knife bank 64 (collectively referred to as a knife bank element) and generates a signal indicative of a sensed position of the knife bank element correlated to the position of the knife bank 64 and/or the distance between the knife bank 64 and the chopping rotor 62.

Optionally, referring to FIG. 6C, a chopping rotor actuator 624 may be coupled to the chopping rotor 62 and is configured to move the chopping rotor 62 toward or away from the knife bank 64. A position sensor 626 is connected to the chopping rotor actuator 624. The position sensor 626 senses the position of the chopping rotor actuator 624 and generates a signal indicative of a sensed position of the chopping rotor actuator 624 correlated to the position of chopping rotor 62.

The crop processing component CPC described herein may include, but is not limited to, at least one of the concave 34 (e.g. the first concave 342 and the second concave 344), the vanes 382 above the axial rotor 32, the louvers 422 of the chaffer 42, the louvers 442 of the sieve 44, the knife bank 64 of the chopper 60, or the chopping rotor 62 of the chopper 60, which are described in detail in FIG. 6C. The present disclosure includes a crop processing component status monitor and control system SMC that may monitor the status of the crop processing component CPC (position, normal or abnormal status) and control the crop processing component CPC and other component for adjustment, calibration, or alert.

FIG. 6A illustrates a simplified structure of the crop processing component status monitor and control system SMC for performing auto calibration. The crop processing component status monitor and control system SMC includes at least one optical sensor 70, e.g., a camera, and a controller 80. The optical sensor 70 is configured to capture the image(s) of the crop processing component CPC or elements configured to move the crop processing component (i.e., the actuator or linkage coupled between the actuator and the crop processing component). The number and the locations of the optical sensor 70 are illustrated in FIG. 6C later. The optical sensor 70 then generates a signal indicative of the image of the crop processing component CPC, through an image processing unit 79. The controller 80 may include a control system 82 (or processor 82) and a memory 83 (shown in FIG. 6C). The crop processing component status monitor and control system SMC may also include or cooperate with a position sensing system 84, a machine status monitoring system 85, an auto trigger calibration system 86, and an actuator(s) 88 (driver). The number and the potential locations of the position sensing system 84 and the actuator 88 are illustrated in FIG. 6C later. The numbers and the locations of the crop processing component CPC, the optical sensor(s) 70, the sensing system 84, the actuator 88, and other members are illustrated for demonstrative purposes.

It is noted that, as shown in FIG. 6A, the machine status monitoring system 85 and auto trigger calibration system 86 provide inputs to the control system 82 (processor 82) for the control system 82 (processor 82) to determine whether to start calibrating the crop processing component CPC. The machine status monitoring system 85 is configured to monitor the status of the agricultural harvester 20 and to generate a signal indicative of the status of the agricultural harvester 20. The machine status monitoring system 85 may include a machine status monitor having one or more sensors or receive signals from other controllers or sensor systems. When the agricultural harvester 20 is processing the crop, the processor 82 normally avoids calibration. The optical sensor 70 may not clearly capture the image on the crop processing component CPC due to the crop passing through the crop processing component CPC. In addition, when the image quality captured by the optical sensor 70 is low (dusty, covered with material, etc.) the processor 82 may not perform the calibration. The machine status monitoring system 85 may include a mass flow sensor applied to the feederhouse 28 or some other component of the agricultural harvester 20 to ensure that when mass flow 852 passing through the crop processing component CPC, the control system 82 (processor 82) determines, through the initiation algorithm 832, that the calibration will not be performed. The machine status monitor of machine status monitoring system 85 may include a vehicle position sensor or other receiver to receive signals for the control system 82 (processor 82) of the controller 80 to determine the position or surrounding of the agricultural harvester 20 to identify the machine (agricultural harvester 20) inside or outside field boundary 854. The vehicle position sensor includes the GNSS receiver or optical sensor (camera) that captures images surrounding the agricultural harvester 20. When the agricultural harvester 20 is approaching to the edge of the headlands and going to turn around, the control system 82 may determine, by executing the initiation algorithm 832, the crop will not be passing through the crop processing component CPC for a period of time and therefore determine to execute the status monitor and control algorithm 834 to perform the calibration of the crop processing component CPC. The machine status monitoring system 85 may also include a transmitter to communicate with a workstation or another agricultural harvester, and transmit the signals, based on the communication, to the control system 82 (processor 82) to determine, by executing the initiation algorithm 832, whether the agricultural harvester 20 is operating inside or outside the coverage map 856. The coverage map 856 may include areas that had been harvested. When the agricultural harvester 20 is traveling inside the coverage map 856, this indicates that the agricultural harvester 20 is traveling in the area which had been harvested by the agricultural harvester 20 or another agricultural harvester (not shown). The control system 82 therefore may determine the crop will not be passing through the crop processing component CPC for a period of time and determine to execute the status monitor and control algorithm 834 to perform the calibration of the crop processing component CPC. The machine status monitor of the machine status monitoring system 85 may include various sensors transmitting signals for the control system 82 (processor) to determine, by executing the initiation algorithm 832, whether machine operational status is or is not non-harvesting, transport, or unloading state 858. The various sensors (machine status sensor) may include but are not limited to mass flow sensor, speed sensor(s), strain or torque sensor(s) on the drivetrain, pressure sensor on the hydraulic component such as lift cylinder. The various sensors may also include some other position sensors. For example, the position of the unloader 54 would be an indication of the unloading status, or the position of covers of the grain tank 52 would be an indication of a non-harvesting or transport status. The auto trigger calibration system 86 may include various logic, timer, etc. In some implementation, the machine status monitoring system 85 and the auto trigger calibration system 86 are integrated. Timer may record a time after the last execution of the status monitor and control algorithm. The control system 82 may determine, by executing the initiation algorithm 832, whether to calibrate based on the last calibration time, fixed interval (e.g., whether the time is greater than a pre-determine threshold), and other trigger conditions.

FIG. 6B is another simplified block diagram of the crop processing component status monitor and control system SMC, which monitors an abnormal status and alerts the operator. The optical sensor 70, the image processing unit 79, the control system 82 (or processor 82), and the machine status monitoring system 85 are elaborated in the description of FIG. 6A. The inputs from the machine status monitoring system 85 may help the control system 82 determine whether it is a proper time to monitor the crop processing component CPC. The control system 82 may determine, by executing the initiation algorithm 832, the crop will not be passing through the crop processing component CPC for a period of time (or the agricultural harvester 20 is approaching the edge of the headlands, the agricultural harvester 20 is traveling inside the coverage map 856, or the machine operational status is non-harvesting, transport, or unloading state) to determine to execute the status monitor and control algorithm 834 to monitor the crop processing component CPC. Once the control system 82 determines an abnormal status is present on the crop processing component CPC, the control system 82 (processor 82) executes the status monitor and control algorithm 834 to transmit an alert signal to an output device 244.

It is noted that the members for calibration and members for abnormal status detection and alert may not be mutually exclusive. Instead, they may both receive information from the optical sensor 70, processes the image through the image processing unit 79, the control system 82, etc. FIG. 6C delineates members of the crop processing component status monitor and control system SMC.

Referring to FIGS. 6A-6C, as well as FIG. 2A-5B, the optical sensor 70 includes an optical sensor 69 capturing the image of the deck plates 294, an optical sensor 71 capturing the image of the first concave 342, an optical sensor 72 capturing the image of the second concave 344, an optical sensor 73 capturing the image of the vanes 382, an optical sensor 74 capturing the image of the louvers 422 of the chaffer 42, an optical sensor 75 capturing the image of the louvers 442 of the sieve 44, an optical sensor 76 capturing the image of the chopping rotor 62, an optical sensor 77 capturing the image of the knife bank 64, and an optical sensor 78 capturing the image of the shaking pan 41. The optical sensor 70 then generates signal(s) of the crop processing component CPC (e.g., deck plates 294, first concave 342, second concave 344, vanes 382, shaking pan 41, louvers 422, louvers 442, chopping rotor 62, knife bank 64) to the controller 80. The actuator(s) 88 may include at least one of the aforementioned actuators, such as the deck plates actuator 296, the concave actuator 362, the concave actuator 366, the vane actuator 384, the chaffer actuator 424, the sieve actuator 444, the chopping rotor actuator 624, and the knife bank actuator 644, respectively move the corresponding crop processing component CPC to different positions. The position sensing system 84 may include at least one of the aforementioned position sensors, such as position sensors 364, 368, 386, 426, 446, 626, 646.

The controller 80 is disposed in communication with the input device 242, the optical sensor 70, the position sensing system 84, a machine status monitoring system 85, an auto trigger calibration system 86 and outputs such as actuator(s) 88 and output device 244. The controller 80 is operable to receive instruction signals from the input device 242, receive image signals from the optical sensor 70, receive signals indicative of a sensed position of the actuator 88 from the position sensing system 84, and communicate a signal to the outputs like the output device 244 and the actuator 88. While the controller is generally described herein as a singular device, it should be appreciated that the controller may include multiple devices linked together to share and/or communicate information therebetween. Furthermore, it should be appreciated that the controller 80 may be located on the agricultural harvester 20 or located remotely from the agricultural harvester 20.

The controller 80 may alternatively be referred to as a computing device, a computer, a control unit, a control module, a module, etc. The controller 80 includes the processor 82, the memory 83, and all software, hardware, algorithms, connections, sensors, etc., necessary to manage and control the operation of the optical sensor 70, the position sensing system 84, and the outputs like the actuator 88 and the output device 244. As such, a method may be embodied as a program or algorithm operable on the controller 80. It should be appreciated that the controller 80 may include any device capable of analyzing data from various sensors, comparing data, making decisions, and executing the required tasks.

As used herein, “controller 80” is intended to be used consistent with how the term is used by a person of skill in the art, and refers to a computing component with processing, memory, and communication capabilities, which is utilized to execute instructions (i.e., stored on the memory or received via the communication capabilities) to control or communicate with one or more other components. In certain embodiments, the controller 80 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals). For example, the position sensor 426 is coupled to the actuator 424 that is operatable to move the louvers 422 of the chaffer 42, and the controller 80 may receive signals indicative of a sensed actuator position represented by an electric value from the position sensor 426. The electric value herein may be a voltage value corresponding to the sensed position of the actuator 424 correlated the position of the louvers 422.

The controller 80 may be in communication with other components on the agricultural harvester 20, such as hydraulic components, electrical components, and operator inputs within an operator station of an associated work vehicle. The controller 80 may be electrically connected to these other components by a wiring harness such that messages, commands, and electrical power may be transmitted between the controller 80 and the other components. Although the controller 80 is referenced in the singular, in alternative embodiments the configuration and functionality described herein can be split across multiple devices using techniques known to a person of ordinary skill in the art.

The controller 80 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. The memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The controller 80 includes the tangible, non-transitory memory 83 on which are recorded computer-executable instructions, including the initiation algorithm 832 and the status monitor and control algorithm 834. The processor 82 of the controller 80 is configured for executing the initiation algorithm 832 and status monitor and control algorithm 834. The initiation algorithm implements a method of determining whether to execute the status monitor and control algorithm 834, based on the inputs from machine status monitoring system 85, the auto trigger calibration system, 86, etc. The processor 82 is configured to execute the initiation algorithm 832 to receive the signal indicative of the status of the agricultural harvester 20 and determine whether to execute the status monitor and control algorithm based on the signal indicative of the status of the agricultural harvester. The status monitor and control algorithm 834 implements a method to monitoring and controlling the crop processing component CPC and output device 244, described in detail below.

The processor 82 is operable to execute the status monitor and control algorithm 834 to receive the signal indicative of the image of the crop processing component CPC from the optical sensor 70, to analyze the image of the crop processing component CPC to obtain a value, and to determine, based on the value, the status of the crop processing component CPC. The status of the crop processing component CPC may be a position of the crop processing component CPC, or abnormal status or normal status on the crop processing component CPC.

When the processor 82 executes the status monitor and control algorithm 834 to identify the position of the crop processing component CPC based on the value, in one implementation, the position of the crop processing component CPC may be used to move the crop processing component CPC precisely. Take the louvers 422 of the chaffer 42 for example. When the operator uses the input device (e.g., a touch screen) setting a desired position of the louvers 422, which reflects 16 mm opening, the optical sensor 74 captures image of the louvers 422 and generate a signal indicative of the image of the louvers 422. The processor 82 executes the status monitor and control algorithm 834 to receive the signal indicative of the image of the louvers 422, to analyze the image of the louvers 422 to obtain a value, to determine, based on the value, the position of the louvers 422. Such determination based on the image of the louvers 422 may be a ground truth value. Then the processor 82 executes the status monitor and control algorithm 834 to compare the position of the louvers 422, derived from the value, with a desired position (here, 16 mm opening). When the position of the louvers 422 is not the desired position, the processor 82 commands the actuator 424 to move the louvers 422 from the current position to the desired position. This is a closed loop control that automatically adjusts the position of the louvers 422 to the desired position. However, if the louvers 422 cannot reach the desired position, the opening of the louvers 422 (chaffer opening) may be plugged or some other component of the chaffer 42 may be damaged to cause such abnormal status on the chaffer 42. Then the processor 82 executes the status monitor and control algorithm 834 to activate the output device 244 to alert the operator. Likewise, other processing component CPC, such as the first concave 342, the second concave 344, the vanes 382, the louvers 442, the chopping rotor 62, and the knife bank 64 may be moved to respective desired positions through similar closed loop control. If the other crop processing component(s) CPC cannot reach the desired position, the abnormal status may be present on the crop processing component(s) CPC. Then the processor 82 executes the status monitor and control algorithm 834 to activate the output device 244 to alert the operator. This closed-loop adjustment and alert may be a part of calibration or an independent process. The latter may also be applied to a crop processing system (not shown) without installing a position sensor coupled to an actuator that moves the crop processing component CPC. Alternatively, if an abnormal status (such as material build up, excessive material wear, component damage) is detected, the processor 82 executes the status monitor and control algorithm 834 to activate the output device 244 to alert the operator.

When the processor 82 executes the status monitor and control algorithm 834 to identify the position of the crop processing component CPC based on the value, the position of the crop processing component CPC, determined based on the value, may be used to calibrate the measurement of a position sensor. The position sensor is configured to sense a position of the actuator or a linkage coupled between the actuator and the crop processing component CPC (collectively referred to as the element) and generate a signal indicative of a sensed position of the element correlated to the position of the crop processing component CPC. The processor 82 is operable to execute the status monitor and control algorithm 834 to determine an estimated position of the crop processing component CPC based on the signal indicative of the sensed position of the element, and to calibrate the estimated position of the crop processing component CPC to reflect the position of the crop processing component CPC. In this implementation, the processor 82 may collect two (position) samples for calibration. As to the first sample, the processor 82 executes the status monitor and control algorithm 834 to receive a signal indicative of a first sensed position of the element represented by a first electric value from the position sensor, to receive a signal indicative of the image of the crop processing component CPC (or the element) at a first position of the crop processing component CPC from the optical sensor 70, to analyze the image of the crop processing component (or the element) to obtain a first value corresponding to the first position, and to record a first sample including the first value corresponding to the first position and the first electric value in the memory 83. Then, as to the second sample, the processor 82 executes the status monitor and control algorithm 834 to trigger the actuator to move the crop processing component CPC to a second position, to receive a signal indicative of a second sensed position of the element represented by a second electric value from the position sensor, to receive a signal indicative of the image of the crop processing component CPC (or element) at the second position from the optical sensor 70, to analyze the image of the crop processing component CPC at the second position to obtain a second value corresponding to the second position, to record a second sample including the second value corresponding to the second position and the second electric value, and to generate a correlation between the value corresponding to the position of the crop processing component and an electric value from the position sensor based on the first sample and the second sample. The processor 82 may collect more samples. The correlations can be embodied in a dynamic model, in a look up table, etc. The correlations can be stored in memory 83, where they are accessed by processor 82, during run time. They can be stored and used in other ways as well. After the calibration, even if the crop processing component is processing the crop and the optical sensor 70 cannot capture the image, the measurement of the position sensor of the position sensor system can still be used to accurately calculate the position of the crop processing component.

Take the louvers 422 of the chaffer 42 for example. As to the first sample, the processor 82 executes the status monitor and control algorithm 834 to receive a signal indicative of a first sensed position of the actuator 424 (or a linkage coupled between the actuator 424 and the louvers 422) represented by a first electric value (e.g., 0.8 volt) from the position sensor 426, to receive a signal indicative of the image of the louvers 422 at a first position (e.g., 10 mm) from the optical sensor 74, to analyze the image of the louvers 422 to obtain a first value corresponding to the first position, and to record a first sample including the first value corresponding to the first position (10 mm) and the first electric value (0.8 volt) in the memory 83. Then, as to the second sample, the processor 82 executes the status monitor and control algorithm 834 to trigger the actuator 424 to move the louvers 422 to a second position (e.g. 15 mm), to receive a signal indicative of a second sensed position of the actuator 424 (or the linkage) represented by a second electric value (1.2 volt) from the position sensor 426, to receive a signal indicative of the image of the louvers 422 at the second position from the optical sensor 74, to analyze the image of the louvers 422 at the second position to obtain a second value corresponding to the second position, to record a second sample including the second value corresponding to the second position (15 mm) and the second electric value (1.2 volt) to generate a correlation between the value corresponding to the position of the louvers 422 and the voltage from the position sensor based on the first sample and the second sample. The correlations can be embodied in a dynamic model, in a look up table, etc. Any two locations of the louvers 422 with two corresponding electric value can establish such dynamic model for auto calibration. Later, when the louvers 422 cleans the crop and the position sensor 426 senses the position of the actuator 424 (or the linkage) and transmits a third electric value, which is 1.0 volt in this example, the processor 82, based on the correlation established by the two samples, may determine the opening is around 10 mm. Likewise, for other processing component CPC, such as the deck plates 294, the first concave 342, the second concave 344, the vanes 382, the louver 442, the chopping rotor 62, and the knife bank 64, the processor 82 may collect at least two samples, each of which has the crop processing component's position and the corresponding electric value to establish a dynamic model or look up table for auto calibration.

As discussed, the processor 82 is operable to execute the status monitor and control algorithm 834 to determine the status of the crop processing component CPC. The status of the crop processing component CPC may include abnormal status or normal status on the crop processing component CPC. In one implementation, the controller 80 analyzes the image of the current crop processing component CPC, via object-based image analysis, for example, including assigning different areas of the crop processing component CPC with a respective value (classification), and comparing those with images of the crop processing component CPC in normal status. Then the controller 80 determines whether an abnormal status is present on the crop processing component. The abnormal status includes but is not limited to plugging, material build up, wear or damage on the deck plates, the first concave 342, the second concave 344, the vanes 382, the shaking pan 41, the louvers 422, the louvers 442, the chopping rotor 62, the knife bank 64, or other crop processing components.

The present disclosure includes a method of calibration and abnormal status detection.

S1: Start.

S2: Machine status monitoring. The machine status monitoring, as discussed, includes without limitations, at least one of monitoring the mass flow, whether the agricultural harvester is inside, outside, or near the field boundary, whether the agricultural harvester is outside or inside the coverage map, and whether the machine operation status is non-harvesting, transport or unloading state.

S3: Input last calibration time, fixed Interval, auto trigger conditions to the controller. For example, one auto trigger condition defines the next calibration time based on the fixed interval and the last calibration.

S4: Determine whether calibration interlocks are satisfied, through the execution of the initiation algorithm. If it is satisfied, go to S5. If it is not satisfied, go to S1. The calibration interlocks are programmed in the initiation algorithm 832 and are configured to determine whether the calibration should be performed. For example, when one of the auto trigger conditions is met (e.g., time is greater than the threshold, defined by the last calibration time and the fixed interval), the calibration may not start because the input from machine status monitoring indicates now is not an appropriate time to calibrate. Likewise, when the input from machine status monitoring indicates now is an appropriate time to calibrate but auto trigger condition is not met (e.g., just performed calibration short time ago), the calibration may not start. When the auto trigger condition(s) are met and machine status is proper, i.e., calibration interlocks satisfied, the calibration is initiated.

S5: Initialize calibration.

S6: Capture images of a crop processing component.

S7: Analyze images of the crop processing component to obtain a first value corresponding to a first position (current position) of the crop processing component.

S8: Sense position of an actuator or linkage (collectively referred to as an element) that is used to move the crop processing component to obtain a first electric value corresponding to a first sensed position.

S9: Record first sample including the first value corresponding to the first position of the crop processing component and the first electric value corresponding to the first sensed position.

S10: Command the actuator to move crop processing componentry to a new position. The controller may command the actuator automatically. Alternatively, the operator may use the input device to command the actuator to move to the new (desired) position.

S11: Capture images of the crop processing component at a second position.

S12: Analyze images of the crop processing component to obtain a second value corresponding to the second position of the crop processing component.

S13: Sense position of the element (actuator or linkage) to obtain a second electric value corresponding to a second sensed position.

S14: Record samples including the second value corresponding to the second position of the crop processing component and second electric value corresponding to the second sensed position.

S15: Determine whether the desired position is achieved (whether second position is at the desired position). If yes, go to S16-1. If no, go to S16-2.

S16-1: Determine whether the sample number is equal to or greater than the required number. If yes, go to S17-1. If no, go to S10.

S16-2: If the crop processing component is not moved to the desired position, the number of attempts that the actuator has performed reaches the limit? If yes, go to S17-2. If no, go to S10.

S17-1: Generate a correlation between the value corresponding to the position of the crop processing component and the electric value from the position sensor, based on the samples.

S17-2: Trigger diagnostic trouble codes (DTC), and output device, commanded by the controller, to alert the operator.

S18: End.

The present disclosure includes another method of abnormal status detection.

M1: Receive an agricultural harvester's (machine) location.

M2: Capture images of a crop processing component.

M3: Receive last detection time from a memory.

M4: Process data related to the agricultural harvester's location, the image of the crop processing component, and the last detection time.

M5: Monitor machine status.

M6: Determine whether detection status is satisfied or whether time since last detection a threshold is satisfied. If yes, go to M7. If no, go to M4. It is noted that the detection status is the appropriate status for detection, based on the machine status monitoring. For example, mass flow of the crop is not present, the agricultural harvester is near or inside the field boundary, the harvester's operational state is one of non-harvesting state, transport state, or unloading state, and/or the agricultural harvester is located inside or outside coverage map.

M7: Start detection mechanism (Analyze the image).

M8: Determine whether the abnormal status is present on crop processing component. If yes, go to M9. If no, go to M3 to save the current time, which will be the last detection time, and/or go to M4 for data processing after fixed time interval. M9: Alert the operator.

Without in any way limiting the scope, interpretation, or application of the claims appearing below, a technical effect of one or more of the example embodiments disclosed herein is to provide an auto-adjustment of a crop processing component to a desired position, with or without a position sensor sensing an actuator that moves the crop processing component to engage the crop. Another technical effect of one or more of the example embodiments disclosed herein is to provide auto-calibration for the measurement of a position sensor sensing an actuator to obtain the information about the position of the crop processing component. Another technical effect of one or more of the example embodiments disclosed herein is to provide an abnormal status checking on the crop processing component.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally,” “substantially” or “approximately” are understood by those of ordinary skill to refer to reasonable ranges outside of a given value or orientation, for example, general tolerances or positional relationships associated with manufacturing, assembly, and use of the described embodiments.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An agricultural harvester, comprising:
a frame having a first end and a second end spaced from the first end along a central longitudinal axis of the frame;
a ground engaging device coupled to the frame and configured to move the frame in a direction of travel during an operation;
a header configured to collect crop and convey the crop to a feederhouse coupled between the header and the frame;
a crop processing system including:
a crop processing component configured to engage the crop; and
an actuator coupled with the crop processing component and configured to move the crop processing component to engage the crop; and
a crop processing component status monitor and control system including:
an optical sensor configured to capture an image of the crop processing component or an element coupled to or included by the actuator and to generate a signal indicative of the image of the crop processing component or the element; and
a controller including a processor and a memory having a status monitor and control algorithm stored therein, wherein the processor is operable to execute the status monitor and control algorithm to:
receive the signal indicative of the image of the crop processing component or the element from the optical sensor;
analyze the image of the crop processing component or the element to obtain a value; and
determine, based on the value, the status of the crop processing component.

2. The agricultural harvester of claim 1, wherein determining the status of the crop processing component includes determining whether an abnormal status is present on the crop processing component.

3. The agricultural harvester of claim 2, wherein the processor is operable to execute the status monitor and control algorithm to transmit an alert signal to an output device when the processor determines the abnormal status is present on the crop processing component.

4. The agricultural harvester of claim 1, wherein determining the status of the crop processing component includes identifying a position of the crop processing component based on the value.

5. The agricultural harvester of claim 4, wherein the processor is operable to execute the status monitor and control algorithm to:
compare the position of the crop processing component, derived from the value, with a desired position set by an output device; and
command the actuator to move the crop processing component from the position to the desired position when the position of the crop processing component is not the desired position.

6. The agricultural harvester of claim 4, further comprising a position sensor configured to sense a position of the element coupled to or included by the actuator and generate a signal indicative of a sensed position of the element correlated to an estimated position of the crop processing component; and
wherein the processor is operable to execute the status monitor and control algorithm to determine the estimated position of the crop processing component based on the signal indicative of the sensed position of the element and to calibrate the estimated position of the crop processing component, based on the value, to reflect the position of the crop processing component.

7. The agricultural harvester of claim 6, wherein the processor executes the status monitor and control algorithm to:
receive a signal indicative of a first sensed position of the element represented by a first electric value from the position sensor;
receive a signal indicative of the image of the crop processing component or the element at a first position of the crop processing component from the optical sensor;
analyze the image of the crop processing component or the element at the first position of the crop processing component to obtain a first value corresponding to the first position; and
record a first sample including the first value corresponding to the first position and the first electric value.

8. The agricultural harvester of claim 7, wherein the processor executes the status monitor and control algorithm to:
trigger the actuator to move the crop processing component to a second position;
receive a signal indicative of a second sensed position of the element represented by a second electric value from the position sensor;
receive a signal indicative of the image of the crop processing component or the element at the second position of the crop processing component from the optical sensor;
analyze the image of the crop processing component or the element at the second position to obtain a second value corresponding to the second position;
record a second sample including the second value corresponding to the second position and the second electric value; and
generate a correlation between the value corresponding to the position of the crop processing component and an electric value from the position sensor based on the first sample and the second sample.

9. The agricultural harvester of claim 4, wherein the crop processing component includes louvers of a sieve or louvers of a chaffer, and the position of the crop processing component reflects the opening defined by the louvers of the sieve or louvers of the chaffer.

10. The agricultural harvester of claim 1, wherein the crop processing component includes a deck plate of the header, louvers of a sieve, louvers of a chaffer, separator vanes, a concave, a shaking pan, a chopping rotor of a chopper, or a knife bank of the chopper.

11. The agricultural harvester of claim 1, further comprising a machine status monitoring system configured to monitor the status of the agricultural harvester and generate a signal indicative of the status of the agricultural harvester;
wherein the memory includes an initiation algorithm stored therein; and
wherein the processor is configured to execute the initiation algorithm to:
receive the signal indicative of the status of the agricultural harvester; and
determine whether to execute the status monitor and control algorithm based on the signal indicative of the status of the agricultural harvester.

12. The agricultural harvester of claim 11, wherein the machine status monitoring system includes a machine status monitor or a timer configured to record a time after a last execution of the status monitor and control algorithm.

13. The agricultural harvester of claim 12, wherein the processor determines whether to execute the status monitor and control algorithm based on whether the time is greater than a threshold.

14. The agricultural harvester of claim 11, wherein the status of the agricultural harvester includes at least one of a presence of a mass flow of the crop, a position of the agricultural harvester relative to a field boundary position, an operational state of the agricultural harvester, or the position of the agricultural harvester located inside or outside coverage map.

15. The agricultural harvester of claim 14, wherein the operational state includes non-harvesting state, transport state, or unloading state.

16. The agricultural harvester of claim 14, wherein the machine status monitor includes at least one of a mass flow sensor configured to sense the mass flow of the crop, a speed sensor, a vehicle position sensor, or a receiver configured to receive a signal from another agricultural harvester or an operation station.

17. A method of monitoring and controlling a crop processing component of an agricultural harvester, the method comprising:
capturing an image of the crop processing component and generating a signal indicative of the image of the crop processing component by an optical sensor;
receiving the signal indicative of the image of the crop processing component from the optical sensor by a controller;
analyzing the image of the crop processing component, by the controller, to obtain a value; and
determining, based on the value, the status of the crop processing component.

18. The method of claim 17, wherein determining the status of the crop processing component includes determining whether an abnormal status is present on the crop processing component.

19. The method of claim 17, wherein determining the status of the crop processing component includes identifying a position of the crop processing component based on the value, wherein the crop processing component is moved by an actuator to engage the crop.

20. An agricultural harvester, comprising:
a frame having a first end and a second end spaced from the first end along a central longitudinal axis of the frame;
a ground engaging device coupled to the frame and configured to move the frame in a direction of travel during an operation;
a header configured to collect crop and convey the crop to a feederhouse coupled between the header and the frame;
a component configured to engage the crop; and
a component status monitor and control system including:
an optical sensor configured to capture an image of the component and to generate a signal indicative of the image of the component; and
a controller including a processor and a memory having a status monitor and control algorithm stored therein, wherein the processor is operable to execute the status monitor and control algorithm to:
receive the signal indicative of the image of the component from the optical sensor;
analyze the image of the component to obtain a value; and
determine, based on the value, the status of the component.
